(19) United States
(12) Patent Application Publication
(10) Pub. No.: US 2008/0298911 A1
(43) Pub. Date: Dec. 4, 2008

(54) Drill template for installing railing brackets

(76) Inventor: Robert E. Platt, Mineral Ridge, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/809,989

(22) Filed: Jun. 4, 2007

(51) Int. Cl. B23B 47/28

(52) U.S. Cl. 408/115 R; 408/1 R

(57) ABSTRACT

A drill template for correctly positioning fastener holes on a side wall of a fence post. The drill template comprises a base that includes an alignment mechanism to enable an installer to correctly place the base adjacent a side wall of the fence post. The base of the template includes a plurality of fastener-positioning indicators thereon, each of which is useful to identify a position for drilling a single fastener hole in the side wall of the fence post. The template also includes a slider that is movable along the base to select which of the plurality of fastener-positioning indicators to use. The slider includes a plurality of apertures that are alignable with the fastener-positioning indicators. Preferably, the fastener positioning indicators are holes that are defined in the base. The installer sequentially inserts a drill bit through each one of the aligned apertures and indicator holes and drills the fastener holes in the post.

### BACKGROUND OF THE INVENTION

1. Technical Field

This invention generally relates to fencing systems. More particularly, the invention relates to a template for fence post brackets. Specifically, the invention relates to a drill template that includes a base with an alignment mechanism for correctly positioning the base adjacent a side wall of a fence post and which includes a plurality of fastener-positioning indicators to identify positions for drilling the fastener holes in the side wall.

2. Background Information

One of the problems that vinyl fencing system installers face is related to correctly positioning fence rails on fence posts. Rail mounting brackets may be installed at the wrong height from the post-mounting surface because of variations in fence post heights and inaccurate measurement by the installer. These errors tend to result in aesthetically displeasing fences with posts sticking above the rails to different degrees.

There is therefore a need in the art for a reliable way to position railing brackets so that the brackets are installed at predictable, predetermined heights on the posts.

### SUMMARY OF THE INVENTION

The device of the present invention comprises a drill template for correctly positioning fastener holes for brackets on a side wall of a fence post. The drill template comprises a base that includes an alignment mechanism to enable an installer to correctly place the base adjacent a side wall of the fence post. The base of the template includes a plurality of fastener-positioning indicators thereon, each of which is useful to identify a position for drilling a single fastener hole in the side wall of the fence post. The template also includes a slider that is movable along the base to select which of the plurality of fastener-positioning indicators to use. The slider includes a plurality of apertures that are alignable with the fastener positioning indicators. Preferably, the fastener positioning indicators are holes that are defined in the base. The installer sequentially inserts a drill bit through each one of the aligned apertures and indicator holes and drills the fastener holes in the post.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a front elevational view of a fence system installed using the drill template of the present invention;

FIG. 2 is an exploded perspective view of a fence post and the drill template of the present invention;

FIG. 3 is an exploded perspective rear view of a slider used on the drill template;

FIG. 4 is a perspective rear view of the slider;

FIG. 5 is a perspective front view of the slider;

FIG. 6 is a top view of the slider;

FIG. 7 is a perspective view of the drill template engaged with the fence post and in position for use;

FIG. 8 is a perspective view of a first end of the drill template and post as highlighted in FIG. 7;

FIG. 9 is a perspective view of a second end of the drill template and post as highlighted in FIG. 7;

FIG. 10 is a partial cross-sectional top view of the drill template and fence post taken through line 10-10 of FIG. 8;

FIG. 11 is a front view of the drill template and post showing the slider positioned intermediate the first and second indicator holes;

FIG. 12 is a cross-sectional side view of the drill template and post taken through line 12-12 of FIG. 8; and

FIG. 13 is a perspective view of the post showing the fastener holes that have been positioned with the use of the drill template of the present invention.

### DETAILED DESCRIPTION OF THE INVENTION

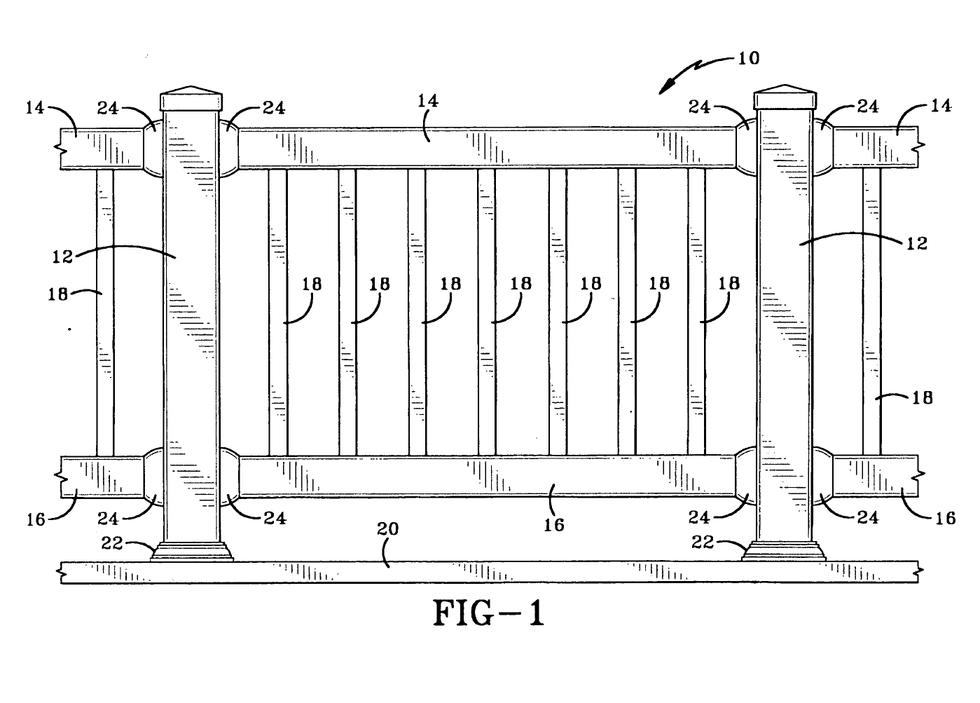

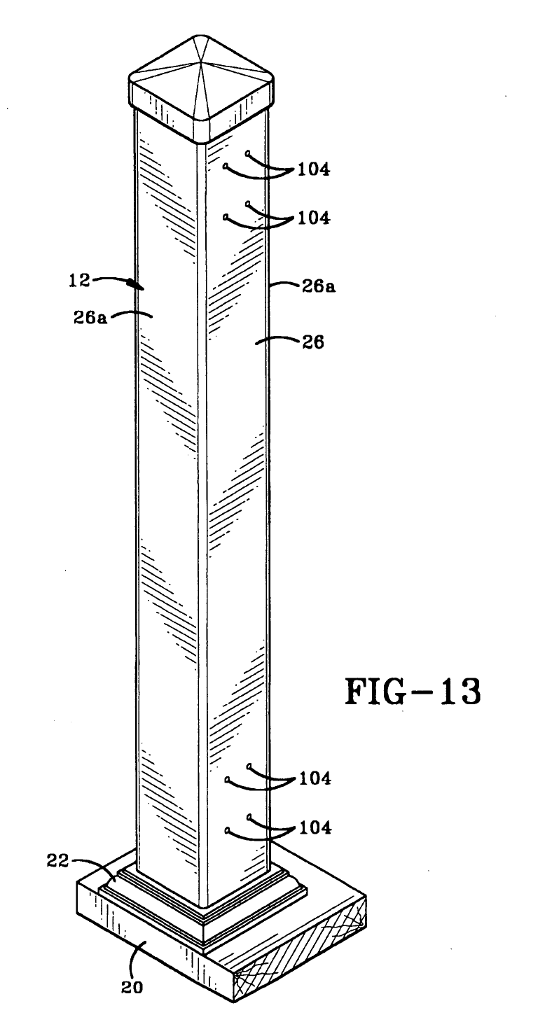

Referring to FIG. 1, there is shown a fence system 10 comprising a pair of adjacent fence posts 12, horizontal fence rails 14, 16 and vertical balusters 18. Posts 12 are vertically mounted in a suitable manner in or on a horizontal surface 20 and a mounting bracket 22 preferably surrounds the base of post 12 and includes a profiled trim section. Fence rails 14, 16 are connected to posts 12 using railing brackets 24. The present invention is directed to a device and method for correctly positioning fastener holes 104 (FIG. 13) on the side walls 26 of post 12 that are used to receive fasteners (not shown) and thereby secure the railing brackets 24 to post 12.

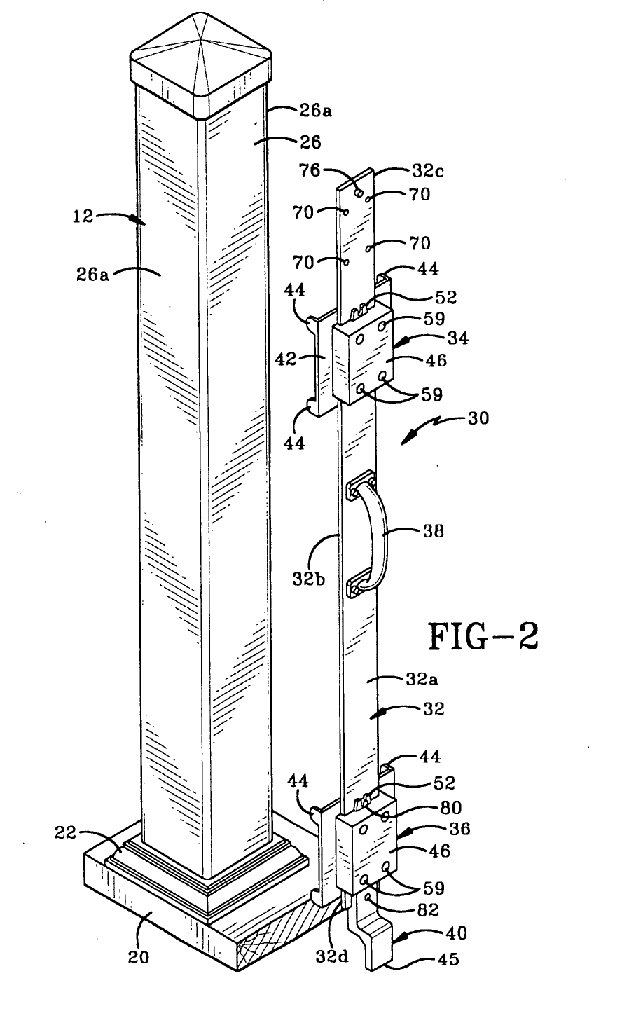

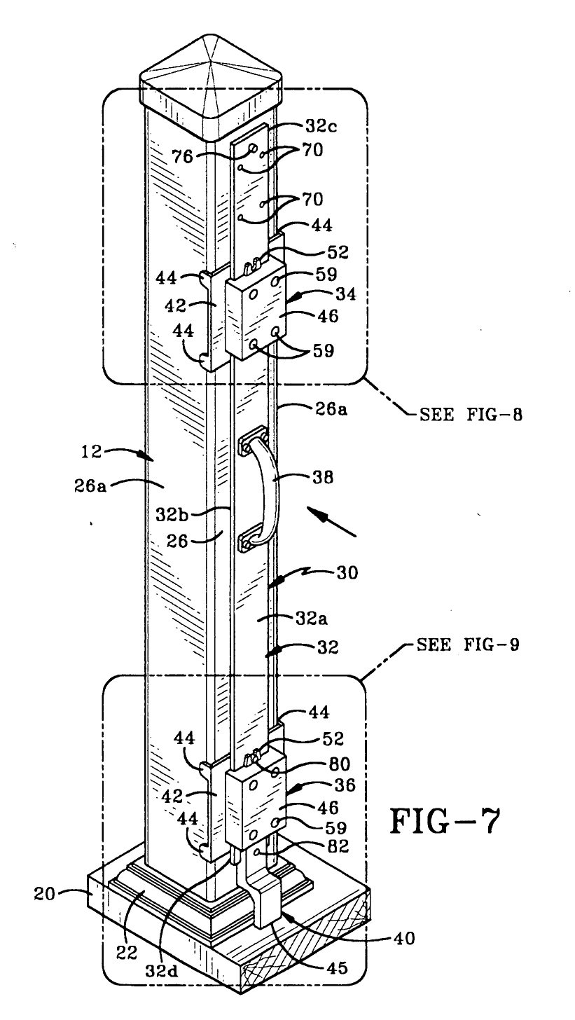

Referring to FIGS. 2-12 there is shown a drill template device 30 in accordance with the present invention. Drill template 30 is used to locate and position appropriate locations for drilling fastener holes 104 on side walls 26 of post 12. Drill template 30 comprises a base 32 having a pair of movable sliders 34, 36 engaged therewith. Base 32 is an elongated planar member having a front surface 32a, a back surface 32b (FIG. 12), a first end 32c and a second end 32d. A handle 38 is provided on front surface 32a preferably in a region midway between first and second ends 32c, 32d. Handle 38 is used by the installer to hold and manipulate drill template 30.

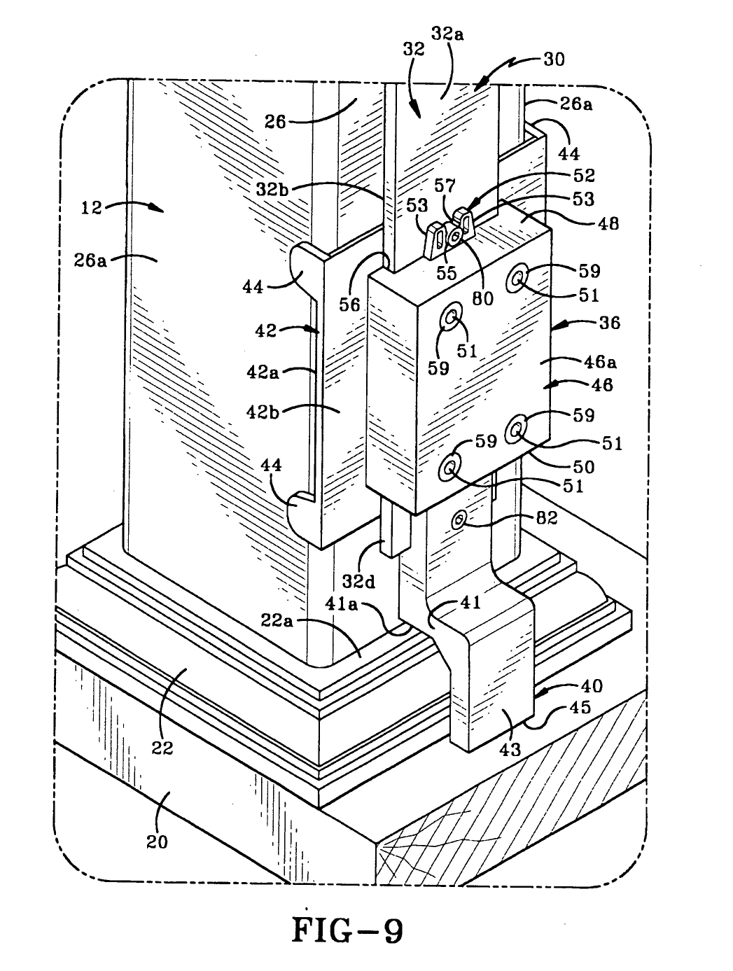

In accordance with a specific feature of the present invention, and as shown in FIGS. 2 and 9, second end 32d of base 32 is provided with a mechanism for correctly aligning template 10 on post 12. The alignment mechanism preferably comprises a substantially L-shaped spacer 40 that extends outwardly from second end 32d of base 32 and is secured thereto by a bolt 82. Spacer 40 is provided to position drill template 30 in a specific location on post 12. Spacer 40 includes a first leg 41 (FIG. 9) that extends substantially horizontally away from the front surface 32a of base 32 and a second leg 43 that extends downwardly from first leg 41 and terminates in a terminal end 45. Second leg 43 is oriented to be generally parallel to front surface 32a of base 32. Terminal end 45 of spacer 40 is positionable on surface 20 during use. The interior surfaces of first and second legs 41, 43 preferably are contoured to space base 32 a distance away from the trim of mounting bracket 22 so that inner surface 41a of first leg 41 of spacer 40 clears the upper surface 22a of the trim on mounting bracket 22. Furthermore, the complementary profile of spacer 40 conforms to mounting bracket 22 and allows back surface 32b of base 32 to abut side wall 26 of post 12. It will be understood however that the spacer 40 does not need to have a complementary shape to the profile of the trim on bracket 22 in order to template 30 to function properly. Second leg 43 of spacer 40 needs only to be spaced a sufficient distance away from rear surface 32b of base 32 to clear the trim on bracket 22 so that terminal end 45 of base 32 may rest flat on surface 20.

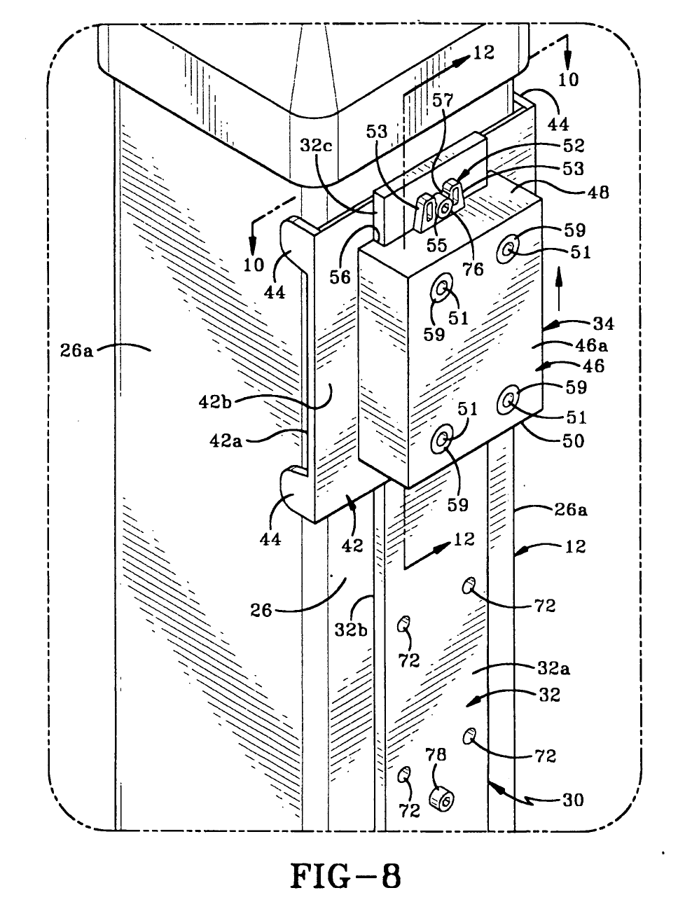

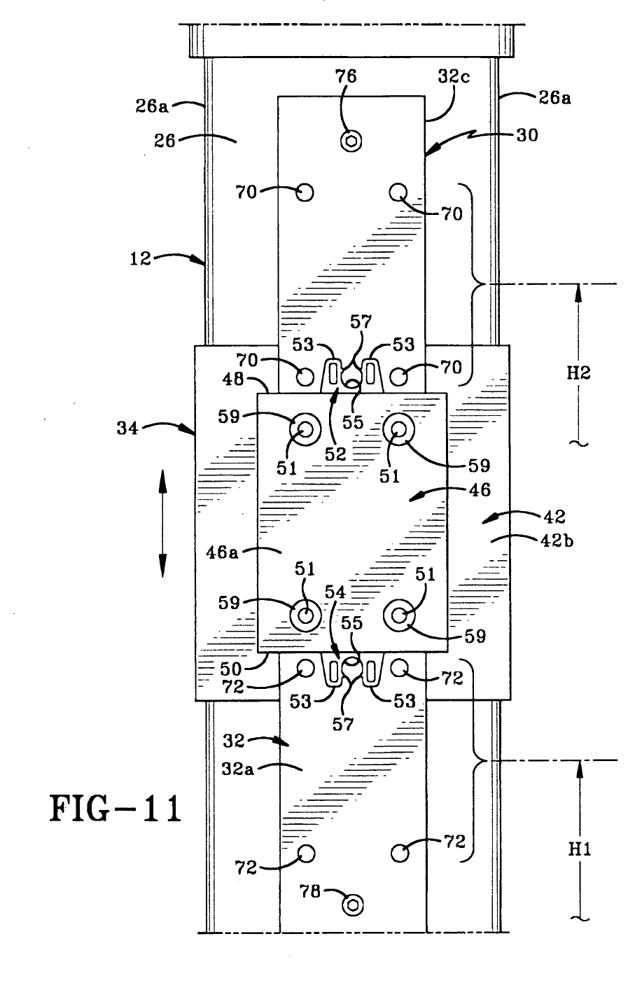

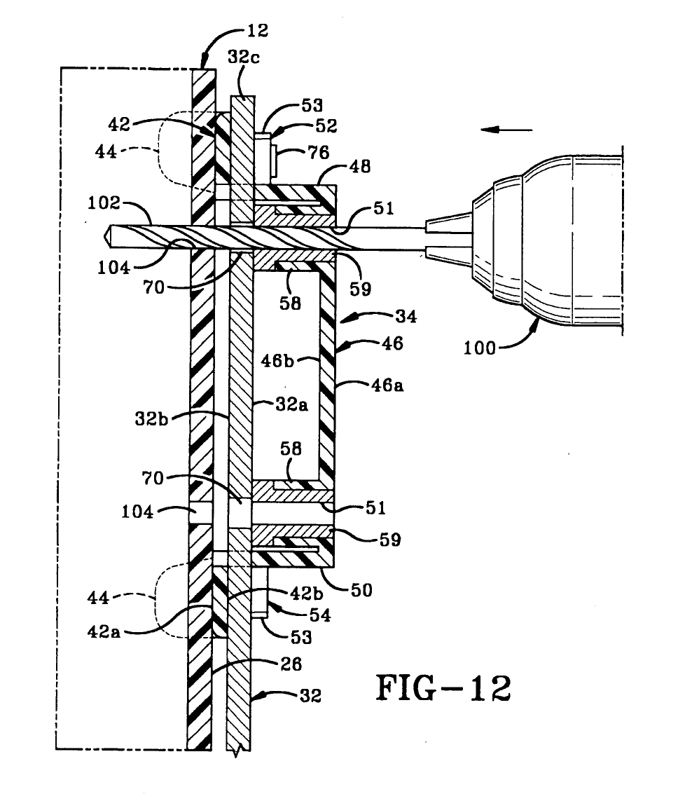

In accordance with another specific feature of the present invention, base 32 includes a plurality of fastener-indicators for positioning the rail mounting brackets. The fastener positioning indicators comprise a plurality of sets of pre-drilled indicator holes that mark the possible positions for drilling fastener holes 104 in post 12. The first set 70 (FIG. 2) of pre-drilled indicator holes in base 32 are proximate first end 32c. A second set (unnumbered) of pre-drilled indicator holes in base 32 are provided proximate second end 32d thereof and behind slider 36. A third set 72 of pre-drilled indicator holes are positioned adjacent first set 70 and are shown in FIGS. 8 and 11. Each of the first, second and third sets of indicator holes includes two pairs of spaced apart and aligned indicator holes. These indicator holes are provided to aid in marking the positions on post 12 where fastener holes 104 (FIG. 13) may be drilled, as will be hereinafter described.

In accordance with yet another feature of the present invention, base is provided with a plurality of stops that are used to position and lock sliders 34, 36 in specific places on base 32. A first stop 76 (FIG. 2) extends outwardly away from front surface 32a of base 32 and intermediate first end 32c and first set of indicator holes 70. A second stop 78 (FIG. 8) extends outwardly from front surface 32a of base 32 adjacent third set of indicator holes 72 and intermediate third set 72 and handle 38. A third stop 80 (FIG. 9) extends outwardly away from front surface 32a of base 32 adjacent the second set of indicator holes (not shown) and intermediate the second set of indicator holes and handle 38.

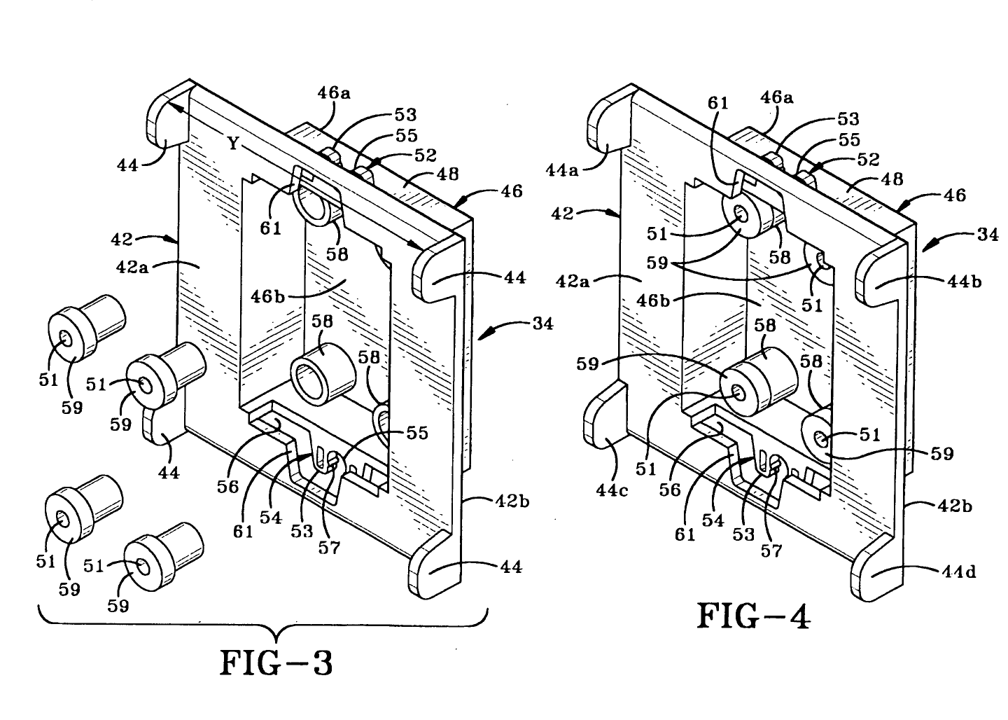

Drill template 30 further includes the first and second sliders 34, 36 that are interlockingly engaged with base 32. Sliders 34, 36 are shown in detail in FIGS. 3-6. The following description will be directed toward slider 34, but it will be understood that slider 36 is substantially identical thereto. Slider 34 includes a planar plate 42 that has a front surface 42b and a rear surface 42a. Plate 42 has a width “W” (FIG. 6) that is greater than that of base 32. A set of four flanges 44 extend outwardly away from back surface 42b of plate 42 and at right angles thereto. Flanges 44 extend outwardly away from the rear surface 42a in two spaced apart and aligned pairs, namely 44a, 44b and 44c, 44d. The interior surfaces of the flanges 44 of each pair are separated by a distance “Y” which is substantially equal to the width of post 12. Thus, when drill template 30 is engaged with post 12, flanges 44 frictionally retain slider 34 on post 12, and thereby retain drill template 30 on post 12.

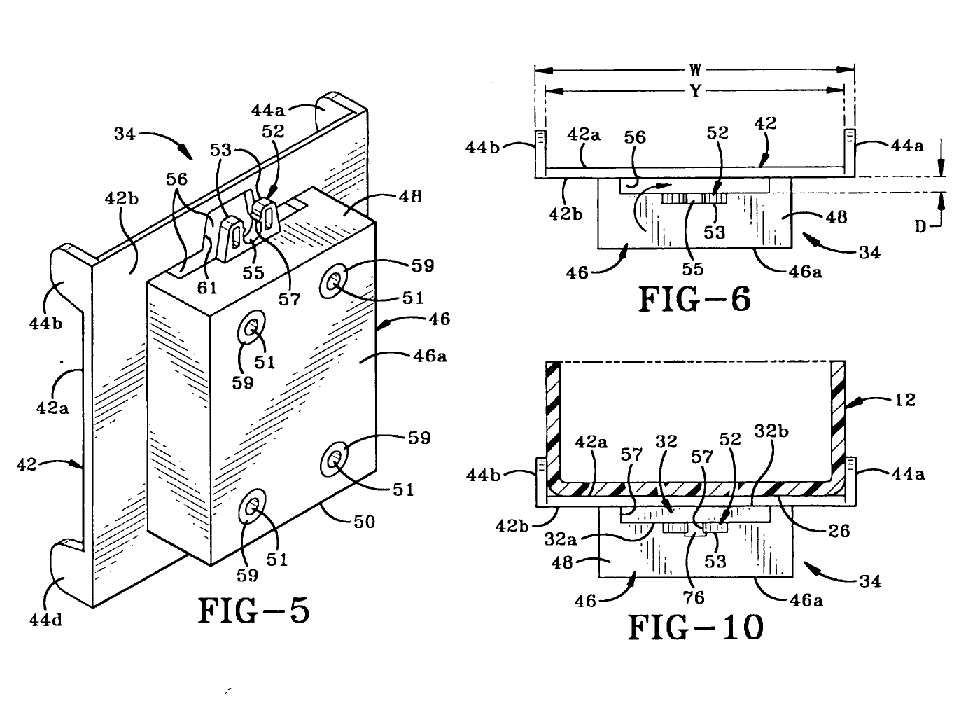

Referring to FIGS. 5, 6, 11 and 12, slider 34 further includes a housing 46 that extends outwardly from plate 42. Housing 46 has a front surface 46a and a back surface 46b (FIG. 12) with front surface 46a beings substantially parallel to the front surface 42a of plate 42 and spaced a distance outwardly away therefrom. A set of four cylindrical bosses 58 extend rearwardly from back surface 46b of housing and terminate a distance inwardly from rear surface 42a of plate 42 (FIG. 3). A bushing 59 is engaged in the bore of each boss 58 and extends forwardly to terminate flush with front surface 46a of housing 46 (FIGS. 4 and 5). Each bushing includes an aperture 51 therein.

Housing 46 also has a first end 48 and a second end 50. First end 48 includes an upper clip 52 and second end 50 includes a lower clip 54 that project outwardly away therefrom and substantially at right angles thereto. Each clip 52, 54 includes a pair of spaced-apart fingers 53 that are separated from each other by a generally U-shaped groove 55. A small shoulder 57 is provided on either side of groove 55. Groove 55 is sized to one of the stops 76, 78 therein and shoulders 57 substantially prevent the one of the stops 76, 78 from accidentally disengaging therefrom. Clips 52, 54 are spaced a distance “D” (FIG. 6) away from front surface 42b of plate 42 such that a gap 56 is created between clips 52, 54 and front surface 42b of plate 42. A slot 57 is provided in each of first and second ends 48, 50 and said gaps 56 and slots 57 are complementary sized and shaped to receive base 32 therethrough as shown in FIG. 12. When base 32 is received through slot 57, an inner surface of clips 52, 54 abut front surface 32a of base 32. Plate 42 further includes a generally U-shaped recess 61 (FIGS. 3-5) therein, in a region rearwardly of each of clips 52 and 54. Recess 61 is provided to allow one of the stops 76, 78 on base 32 to project forwardly through plate 42 and engage the one of the clips 52, 54. When base 32 is received through slot 57, front surface 32a of base 32 engages bosses 59 as shown in FIG. 12.

The drill template 30 of the present invention is used in the following manner. The installer positions terminal end 45 in abutting contact with surface 20 and moves drill template 30 rearwardly until back surface 42a of plates 42 abut side wall 26 of post 12 and flanges 44 frictionally engage sides 26a (FIG. 9). At this point, slider 36 is interlocking engaged with stop 80 and apertures 51 in bushings 59 are aligned with the second set of indicator holes (not shown). The installer must then select the most appropriate position for slider 34 by selecting whether to position slider 34 over first set 70 of indicator holes in base 32 or over third set 72 of indicator holes therein. If the first set 70 is selected, then slider 34 is moved upwardly (FIG. 11) until clip 52 interlocks with stop 76. If the third set 72 is selected, then slider 34 is moved downwardly until clip 54 interlocks with stop 78. In either event, when slider 34 is interlocked with one of stops 76, 78, the apertures 51 therein are aligned with the indicator holes in the appropriate one of the first and second set 70, 72 thereof. The first set 70 of indicator holes will be selected for a tall post 12 and the third set 72 of indicator holes will be selected for a shorter post. The position of the slider 36 is a standard height from the surface 20 upon which post 12 is mounted.

Once the sliders 34 and 36 are correctly positioned for the job at hand, the installer takes a drill 100, inserts a drill bit 102 thereof through a first one of the aligned apertures 51 and indicator holes, such as indicator holes 70 (FIG. 12), activates drill 100 and drills a first one of fastener holes 104 into side wall 26 of post 12. He then inserts drill bit 102 into a second one of the aligned apertures 51 and indicator holes 70 and drills a second fastener hole 104. These steps are repeated until all fastener holes 104 have been made in side wall 26. When both the upper and lower sets of fastener holes 104 have been drilled into side wall 26, drill template 30 is removed from engagement with post 12. The installer will insert fasteners (not shown) through brackets 24 and into fastener holes 104 to secure mounting brackets 24 to post 12.

It will be understood by those skilled in the art that the template may utilize only one slider that is movable between the first and second ends of the base to select any one of the various sets of indicator holes instead of using two sliders to accomplish this purpose.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A drill template for correctly positioning fastener holes on a fence post; said template comprising:
a base;
an alignment mechanism adapted to enable correct placement of the base adjacent a side wall of the fence post; and
a plurality of fastener-positioning indicators provided on the base; each indicator being adapted to identify a position for forming a fastener hole in the side wall of the fence post.

2. The template as defined in claim 1, further comprising a first slider mounted on the base and being movable therealong to selectively align with one of the plurality of indicators.

3. The template as defined in claim 1, wherein the plurality of fastener-positioning indicators comprises:
a first set of indicator holes defined proximate a first end of the base; and
a second set of indicator holes defined proximate a second end of the base; and wherein the first slider is movable between the first and second set of indicator holes.

4. The template as defined in claim 3, wherein the first slider comprises:
a first housing that engages the base;
a plurality of first apertures defined in the first housing; each one of the first apertures being positioned so as to be selectively alignable with one of the indicator holes of one of the first set and second sets thereof.

5. The template as defined in claim 4, further comprising a first stop extending outwardly from an outer surface of said base adjacent one of the first and second sets of indicator holes; and wherein the first housing includes an engagement mechanism for temporarily securing the first slider to the first stop.

6. The template as defined in claim 5, further comprising a second stop extending outwardly away from the outer surface of the base adjacent the other of the first and second set of indicator holes; and wherein the first housing includes a second engagement mechanism for temporarily securing the first slider to the second stop.

7. The template as defined in claim 6, further comprising a second slider; wherein said second slider comprises:
a second housing that is movably mounted on the base;
a plurality of second apertures defined in the second housing; wherein each one of the second apertures is defined at a position that is selectively alignable with one of the indicator holes of one of the first and second sets of indicator holes in the base; and
at least one third engagement mechanism on the second housing; said third engagement mechanism being selectively securable to one of the first and second stops on the base.

8. The template as defined in claim 7, further comprising a third set of indicator holes defined in the first end of the base a spaced distance from the first set of indicator holes therein; and wherein the first slider is movable along the base and is selectively alignable with the indicator holes of either one of the first and third set of indicator holes therein; and wherein the second slider is movable along the base and is alignable with the second set of indicator holes therein.

9. The template as defined in claim 8, further comprising a third extending outwardly from the base adjacent the third set of indicator holes therein; and wherein the first engagement mechanism on the first slider is engageable with the first stop to align the first apertures with the first set of indicator holes; and the second engagement mechanism on the first slider is engageable with the third to align the first apertures with the third set of indicator holes.

10. The template as defined in claim 9, wherein the first, second and third engagement mechanisms on the first and second sliders each comprise a pair of spaced apart fingers separated from each other by a groove.

11. The template as defined in claim 10, wherein the groove is substantially U-shaped and includes a pair of aligned shoulders for frictionally engaging the one of the first, second and thirds therein.

12. The template as defined in claim 1, wherein the alignment mechanism comprises an L-shaped leg extending outwardly from the base; wherein said L-shaped leg includes:
a first arm that extends outwardly from the second end of the base and at right angles to an upper surface thereof;
a second arm that extends outwardly from the first arm and outwardly beyond the second end of the base; and wherein said second arm terminates in a terminal end that is adapted to rest on a fence post supporting surface during marking of the fastener holes on the side wall of the fence post.

13. The template as defined in claim 6, wherein the base is an elongated planar member; and the first housing includes a pair of opposed slots through which the base is received; whereby the slider is movable along the base and at right angles to a longitudinal axis thereof.

14. The template as defined in claim 13, wherein the first housing includes at least one pair of spaced apart flanges that extend rearwardly and outwardly therefrom and are adapted to fictionally engage the fence post therebetween.

15. The template as defined in claim 14, wherein the first housing further comprises a plate member and a box member that extends outwardly from a front surface of the plate member; wherein the opposed slots in the first housing are formed in the box member adjacent the plate member; and wherein the first and second engagement members extend outwardly away from a pair of opposing end walls of the box member.

16. The template as defined in claim 15, wherein the first housing further includes:
a plurality of bosses extending rearwardly from an inner surface of the box member and toward the front surface of the plate member; each boss defining a bore therein; and
a plurality of bushings; each bushing being receivable within the bore of one of the bosses; and wherein each bushing includes a bore therethrough; and each of the bores in the bushings comprises one of the first apertures in the slider.

17. The template as defined in claim 16, wherein each bushing has an interior end that abuts the front surface of the plate and an exterior end that is substantially flush with a front surface of the box member when the bushing is received within the associated boss.

18. A method of marking the positions of holes for fasteners onto a fence post comprising the steps of:
aligning a base of a template on a side wall of the fence post;
aligning a plurality of apertures in a slider of the template with a plurality of fastener-positioning indicators on the base thereof to indicate a plurality of positions where to drill on the side wall of the post;
activating a drill to form a first fastener hole in the side wall of the fence post at a first one of the indicated positions;
drilling a second fastener hole in the side wall at a second one of the indicated positions;
repeating the drilling step until all of the required fastener holes are formed in the side wall of the fence post.

19. The method as defined in claim 18, further comprising the step of:
frictionally engaging the template with the fence post prior to the step of aligning a plurality of apertures in a slider of the template with a plurality of fastener-positioning indicators thereon.

20. The method as defined in claim 18, further comprising the step of:
sliding the slider along the base of the template to select one of the plurality of fastener-positioning indicators.

21. The method as defined in claim 18, further comprising the steps of:
inserting a drill bit through one of the aligned apertures and a bore of one of the fastener-positioning indicators prior to the steps of activating the drill and drilling one of the fastener holes in the side wall of the fence post.
